(19) United States
(12) Patent Application Publication
(10) Pub. No.: US 2014/0012747 A1
(43) Pub. Date: Jan. 9, 2014

(54) Method for Transaction Routing and Processing

(71) Applicant: Basware Corporation, Espoo (FI)

(72) Inventor: Antti NYMAN, Pirkkala (FI)

(21) Appl. No.: 13/926,088

(22) Filed: Jun. 25, 2013

(30) Foreign Application Priority Data
Jul. 4, 2012 (FI) FI20120224

(51) Int. Cl. G06Q 30/04

(52) U.S. Cl. CPC G06Q 30/04
USPC 705/40

(57) ABSTRACT

A computer executable method for routing a plurality of transactions through a router adapted to receive the plurality of transactions comprising at least one first transaction and at least one second transaction from a first system for forwarding the at least one first transaction and at least one second transaction to a second system wherein the routing of the second transaction is conditional to the property of the second transaction and/or to a property of the first transaction. Also an arrangement, a computer program and a router device are disclosed.

### BACKGROUND

Content routing as such is well known in software industry. In general, content routing is used for transmitting content data from a sender to a receiver over a routing network according to the properties of the content data.

In some applications, the content has some special characteristics. For example, transactions may be related to each other. For example, a purchase order may be related to a contract, an invoice may be related to a purchase order or an invoice may be related to another invoice.

Further, in some applications, the transactions that have been routed by a content router from a sender to a receiver (e.g. from a seller to a buyer), may have a long life span. For example, an invoice may be subject to a lengthy approval process before it can be paid by the buyer. There may arise a need for the sender of the transaction to e.g. alter or amend the transaction with some additional data while the original transaction is being processed by the receiver.

An object of the present invention is to disclose a method and an arrangement for providing transaction routing services that address various needs of inter-related and/or long-lived transactions.

### BRIEF DESCRIPTION OF THE INVENTION

The first aspect of the invention is a computer executable method for routing a plurality of transactions in a routing system adapted to receive the plurality of transactions comprising at least one first transaction and at least one second transaction e.g. from a first system for forwarding the at least one first transaction and conditionally the at least one second transaction to a second system. The condition may be related to the property, e.g. data content and/or current state, of e.g. the first or the second transaction.

In an embodiment, the second transaction is adapted to amend or replace the first transaction.

In an embodiment, the method may further comprise e.g. of the step of receiving a first transaction from e.g. the first system, storing at least some data of the first transaction in a storage device of the routing system and routing the first transaction to the second system. The method may further comprise step of receiving e.g. from the first system at least one second transaction having at least one property using which the second transaction is associable with the first transaction, storing at least some data of the second transaction in a storage device of the routing system and associating the second transaction with the first transaction in the routing system. The method may yet further comprise the step of querying at least one property of the first transaction, the property of the first transaction comprising at least one of the current state of the first transaction in the second system, and content data of the first transaction. Still yet further, the method may comprise evaluating, using at least one rule, at least one of a property of the second transaction and the queried property of the first transaction, and according to the result of the evaluation, performing at least one of adapting the routing data of the second transaction, adapting the content data of the second transaction, and creating at least one instruction regarding the processing of the first transaction in the second system.

In an embodiment, the second transaction may be routed to the second system for processing or it may be rejected. A transaction routed to the second system may be accompanied with instructions regarding the workflow of the first or the second transaction. In an embodiment, at least one user of the second system is notified about the second transaction and/or the workflow state change of the first transaction.

In an embodiment, the second transaction comprises a status inquiry of the first transaction.

Another aspect of the present invention is an arrangement comprising at least one server computer. The arrangement is adapted to comprise means for performing the steps of the method of the first aspect of the present invention.

Yet another aspect of the present invention is a computer program product stored in a computer readable memory medium. The product is adapted to comprise computer executable instructions for the purpose of performing a combination of steps of a method disclosed herein using the processor and memory means of the computer.

Still yet another aspect of the present invention is a router comprising means for routing a first transaction and a second transaction e.g. from at least one sender to a recipient according to the data content of the respective transactions, a storage for storing at least some data of the routed transactions, means for determining the current state of at least one previously routed first transaction, means for determining from the data of the storage an association between at least one first and second transactions, and means for amending and/or adapting the data content and/or routing information of at least one second transaction based on the association between the second transaction and a first transaction and/or the current state of at least one first transaction.

### DRAWINGS

Some preferred embodiments of the invention are described below with references to accompanied figures, where:

FIG. 1 depicts an exemplary arrangement according to an embodiment of the present invention,

FIG. 2 shows a flow chart of an embodiment of the method of the present invention,

FIG. 3 shows functional components of a router of an embodiment of the present invention, and

FIG. 4 shows a simplified diagram of a computer usable in various embodiments of the present invention.

### DETAILED DESCRIPTION OF THE INVENTION

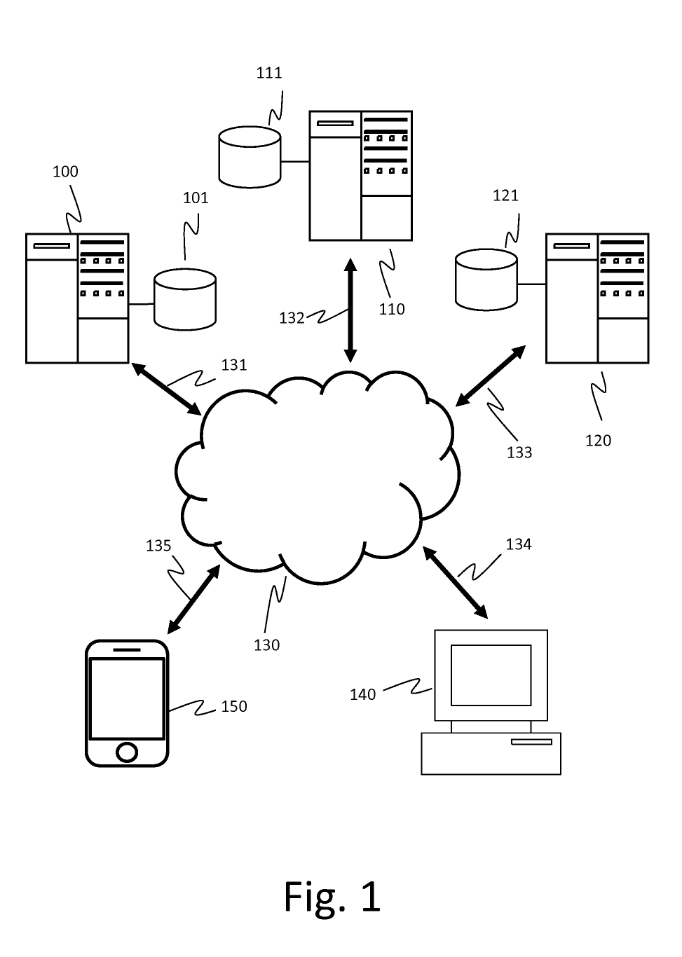

FIG. 1 depicts a computer and data communication arrangement according to a preferred embodiment of the present invention.

The server computer 100 is a source of transactions, e.g. an invoicing system of a seller. The computer 100 sends documents, e.g. invoices, purchase orders or contracts, to the router 110 of the system via a data exchange interfaces 131 and 132 and the data communication network 130. Typically, a copy of the documents resides in the data storage 101 of the server 100. There may be any number of server computers 100 in the system. For example, each seller organization may have its own server 100. There may be also other sources of transactions 100, e.g. organizations that provide financing services of invoices. In an embodiment, a plurality of organizations may share a server 100, thus making the server a multitenant server. In an embodiment, any server of the system may be a multitenant server that is capable of serving a plurality of organizations.

The server computer 110 is the router of the transaction data of the system. The server 110 is thus adapted to receive and send transactions in the system. The router may also be adapted to send and/or receive event and/or instruction data to/from other servers 100, 120. The event data may comprise e.g. state change data of a routed transaction from the recipient system 120. The instruction data may comprise e.g. instructions about executing a transaction in the recipient system 120. For example, the instruction may be related to the workflow management of the routed transaction. In a preferred embodiment, there may be any number of server computers which together provide the router functionality. Advantageously, the storage 111 comprises transaction data, e.g. business documents, e.g. invoices and purchase orders, which each are associable with multiple stakeholder organizations, e.g. sender and recipient, and which are accessible by a plurality of users. The organization data and user data are also stored in the storage 111 of the server 110. In addition to routing transactions and storing the routed data of the system, the router 110 acts as an application server, e.g. as a server providing services that e.g. amend the data of the routed transactions. The users may access the data of the router server 110 via a plurality of terminal computers 140, 150 and data communication interfaces 134, 135 through the application services provided by the router 110.

The server computer 120 depicts an application server that is connected to the network 130 using a data communication interface 133 and that acts as a destination of some transactions routed from the sender server 100 by the router computer 110. The transactions received from the router 110 are stored in the storage 121 of the server. There thus is one copy of a document in the storage 121 and another copy in the storage 111. In an embodiment, the application server of server computer 120 may provide e.g. invoice automation services such as invoice life cycle management services, e.g. invoice approval services. The processing of a single transaction in the application server 120 may require multiple steps between which the transaction remains in an incomplete state in the storage 121. For example, an invoice may require approval from multiple users before it can be paid. Such transactions are called long-lived (or long-running) transactions. There may be any number of servers 120 in the system. For example, there may be separate servers for each organization subscribing to some application service, e.g. an invoice automation service. In a preferred embodiment, the server 120 has a data exchange interface 133, 132 with the server 110 for the purpose of exchanging transaction and/or transaction-related data, e.g. access event data, event data or instructions between the servers 110 and 120.

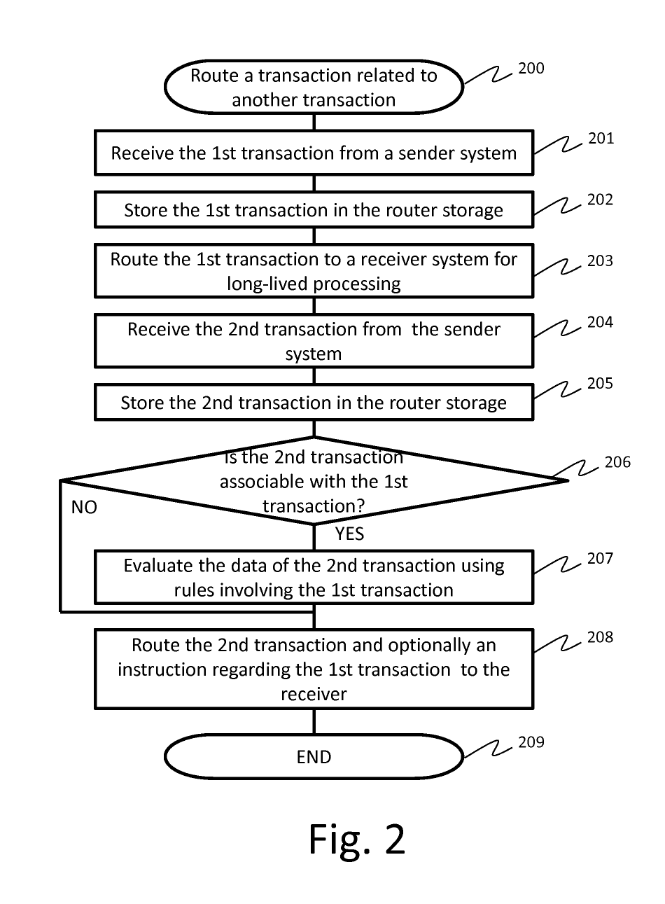

FIG. 2 depicts an exemplary flow chart of the method 200 of routing a transaction related to another transaction according to an embodiment of the present invention.

In the embodiment shown, the computer (100 in FIG. 1) of a seller organization sends a first transaction, e.g. an invoice to the transaction router (110 in FIG. 1) which thus receives the first transaction in step 201. In step 202, the router 110 stores the received transaction in the router storage 111. Next, in step 203, the transaction is routed to the destination computer (120 in FIG. 1). The transaction is advantageously processed in the destination computer as a long-lived transaction, i.e. as a transaction, that is processed in multiple steps and where the transaction is persisted between the steps for a period of time. For example, the transaction may be an invoice, which must be first processed automatically and then approved by a number of users before its processing is complete.

While the invoice is in process in the receiving system 120, the sender, or some other organization that may provide services related to the transactions of the sender, may send to the receiver a second transaction that is somehow related with the first transaction, e.g. that amends the first transaction in some way. For example, the amendment may be about a discount that the sender (e.g. seller) wants to give to the receiver (e.g. buyer), if the receiver is able to execute the transaction, e.g. pay the invoice, sooner than required by the original transaction. In step 204, the router receives thus the second transaction from the sender system (100 in FIG. 1). In an embodiment, the received transaction comprises more than one transaction. For example, a discount obtainable by an expedited payment schedule may be proposed to the buyer as a pair of transactions, where the first part cancels the original transaction and the second part represents a new invoice with a new total amount and due date. The router then stores 205 the second transaction in the router storage (111 in FIG. 1). Next, the router checks if the second transaction is associable with a first transaction 206. For example, the router may search from its storage for an earlier invoice to which the later (pair of) transaction(s) proposes a discount and an expedited payment schedule. If a matching first transaction is found, then the second transaction and the matching first transaction are evaluated using at least one rule 207. The rule may for example check from the second transaction the amount of discount proposed and the new due date. Further, the rule may instruct the router to check from the first transaction its current state in the receiver's system (120 in FIG. 1). The state information may be queried from the receiver's system on-line or the state information may have been imported from the receiver's system to the router's data storage 111 from which it may be queried. The rule may be specified by the receiver of the transaction and it may thus contain preferences of the receiver. The rule may for example allow routing of the second transaction (step 208) to the receiver, if the discount provided exceeds a receiver-given threshold, the new due date is late enough for the buyer's approval process and the original transaction has not been fully approved yet. When the second transaction is routed to the recipient, the router may include into the routed package data that comprises instructions for processing of the first transaction. Such instruction may for example be related to the workflow management of the first transaction, e.g. an instruction to cancel the approval process of the first transaction.

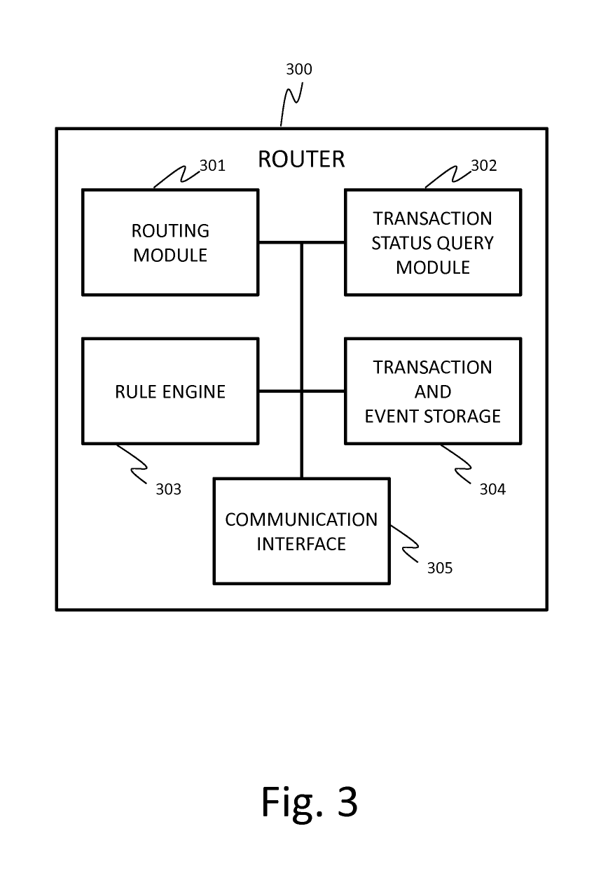

FIG. 3 illustrates some functional components of a router computer 300 (110 in FIG. 1) in a greatly simplified and exemplary manner. The router comprises a routing module 301 which analyses the content of transactions received from the communication interface 305 and determines the recipient of the transaction based on the content of the transaction. The router may utilize the services of the rule engine 303 in the process of determining the recipient. The rule engine 303 may comprise not only rules related to selection of the recipient but also rules for e.g. amending the content of the transactions and associating a routed transaction with another, e.g. previously routed transaction. At least some of the rules may be specified by the users of sending and/or receiving organizations. The transaction status query module 302 comprises means for querying the current processing status of a transaction that has been processed by the router earlier. The query module 302 may use the data of the transaction and event storage 304 in the process of determining the current status of a transaction. The transaction and event data is advantageously received from the senders' and receivers' systems (100 and 120 in FIG. 1) through the communication interface 305.

In a preferred embodiment, the router 300 may also comprise means for identifying, advantageously using the rule engine 303 of the router, a first transaction that may be amended by the second transaction. A user representing the server organization may thus query the router e.g. for invoices, for which an amending (or replacing) transaction is possible at the time of querying. In an embodiment, the user may specify in the query a target, e.g. amount of money receivable by a given date, that the transactions to be selected into the result set must be able to help achieve. In an embodiment, the router may specify in the result set some properties, e.g. amount of discount required, that are needed to achieve the target.

In a preferred embodiment, the router comprises means for notifying a user of the receiving organization about the second transaction and/or amendment(s) to the first transaction.

In an embodiment, the router (110 in FIG. 1) may comprise means, e.g. user interface means, for the user of the receiving organization to approve the routing of the second transaction before the second transaction is routed to the receiving system (120 in FIG. 1).

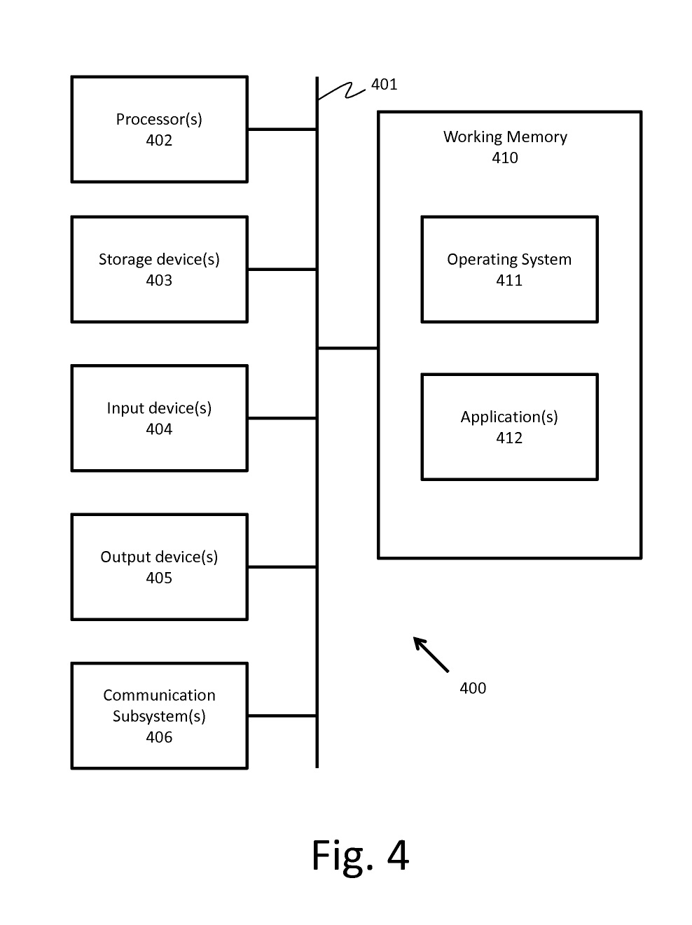

FIG. 4 shows a schematic illustration of one embodiment of a computer system (e.g. 100, 110, 120 of FIG. 1) that can perform the methods of the described embodiment. It should be noted that FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown comprising hardware elements that can be electrically coupled via a bus 401 (or may otherwise be in communication, as appropriate). The hardware elements can include one or more processors 402, communication subsystems 406, one or more input devices 404, which can include without limitation a mouse, a keyboard and/or the like; and one or more output devices 405, which can include without limitation a display device, a printer and/or the like. The computer system 400 may further include (and/or be in communication with) one or more storage devices 403. The computer system 400 also can comprise software elements, shown as being located within the working memory 410, including an operating system 411 and/or other code, such as one or more application programs 412, which may comprise computer programs of the described embodiments, and/or may be designed to implement methods of the described embodiments of a computer-method of the embodiments as described herein.

At least some embodiments include a program storage device readable by a machine, tangibly embodying a program of instructions executable by the machine to perform a computer-executable method of an embodiment of the present invention.

Although specific embodiments have been described and illustrated, the embodiments are not to be limited to the specific forms or arrangements of parts so described and illustrated.

1. A computer executable method for routing a plurality of transactions through a router to a receiving system, wherein the method comprises:
a. receiving at the router the plurality of transactions comprising at least one first transaction and at least one second transaction wherein the second transaction is adapted to amend or replace the first transaction,
b. forwarding the at least one first transaction to the receiving system, and
c. conditionally forwarding the at least one second transaction to the receiving system wherein the condition is associable with a property of the first transaction.

2. A method according to claim 1 wherein the step of conditionally forwarding the at least one second transaction to the receiving system comprises steps:
a. storing at least some data of the second transaction in a storage device of the routing system,
b. associating the second transaction with the first transaction,
c. querying at least one property of the first transaction, the property of the first transaction comprising at least one of:
i. the current state of the first transaction in the receiving system, and
ii. content data of the first transaction,
d. evaluating using at least one rule:
i. a property of the second transaction, and
ii. the queried property of the first transaction, and
e. according to the result of the evaluation, performing at least one of:
i. adapting the routing data of the second transaction,
ii. adapting the content data of the second transaction, and
iii. creating at least one instruction regarding the processing of the first transaction in the receiving system.

3. A computer executable program stored on a computer readable medium for routing a plurality of transactions to a receiving system, wherein the computer program comprises computer executable instructions for:
a. receiving the plurality of transactions comprising at least one first transaction and at least one second transaction wherein the second transaction is adapted to amend or replace the first transaction,
b. forwarding the at least one first transaction to the receiving system, and
c. conditionally forwarding the at least one second transaction to the receiving system wherein the condition is associable with a property of the first transaction.

4. A router, wherein it comprises:
a. means for routing a first transaction and a second transaction to a recipient through a communication interface according to the data content of the respective transactions,
b. a storage for storing at least some data of the routed transactions,
c. means for determining the current state of the first transaction,
d. means for determining from the data of the storage an association between the first and the second transactions wherein the second transaction is adapted to amend or replace the first transaction, and
e. means for amending and/or adapting the data content and/or routing information of the second transaction based on the association between the second transaction and the first transaction and the current state of the first transaction.

5. A router according to claim 4, wherein the means for determining an association between the first and the second transactions comprise a rule engine.

6. A router according to claim 4, wherein the router comprises means for notifying a user of the recipient about the second transaction and/or amendment to the first transaction.

7. A router according to claim 4, wherein the router comprises user interface means for the user of the receiving organization to approve the routing of the second transaction before the second transaction is routed to the receiving system.
